(19) United States
(12) Patent Application Publication
(10) Pub. No.: US 2024/0332638 A1
(43) Pub. Date: Oct. 3, 2024

(54) HOUSING CONTAINER

(71) Applicants: Futaba Corporation, Chiba-ken (JP); HONDA MOTOR CO., LTD., Tokyo (JP)

(72) Inventors: Tadao SUZUKI, Chiba-ken (JP); Tomoki ARIHARA, Chiba-ken (JP); Wataru SHIMIZU, Saitama (JP)

(73) Assignees: Futaba Corporation, Chiba-ken (JP); HONDA MOTOR CO., LTD., Tokyo (JP)

(21) Appl. No.: 18/594,280

(22) Filed: Mar. 4, 2024

(30) Foreign Application Priority Data
Mar. 30, 2023 (JP) 2023-055717

(51) Int. Cl. H01M 10/42; H01M 50/107

(52) U.S. Cl. CPC H01M 10/4214; H01M 50/107

(57) ABSTRACT

A housing container includes a plurality of exterior walls, the plurality of exterior walls forming an internal space for housing a content. A part or a whole of the plurality of exterior walls has a pressure adjusting portion formed therein. The pressure adjusting portion includes a pressure plate that is elastically deformable according to a volume change in the internal space.

### CROSS-REFERENCE TO RELATED APPLICATIONS

This application claims the benefit of priority from Japanese Patent Application No. 2023-055717, filed on Mar. 30, 2023, the entire contents of which are incorporated herein by reference.

### BACKGROUND

The present disclosure relates to a housing container that adjusts pressure of an inside of a container by changing in shape.

In recent years, an all-solid-state battery using an inorganic solid electrolyte has been drawing attention as a secondary battery to be used in various kinds of electronic apparatuses or the like. The inorganic solid electrolyte is generally noncombustible due to properties thereof. Thus, the all-solid-state battery using the inorganic solid electrolyte has a high degree of safety as compared with a secondary battery using an organic solvent electrolyte.

For the maintenance of performance of such an all-solid-state battery, it is considered to be effective to apply a constant pressure within a container housing battery elements of the all-solid-state battery, at all times, in order to decrease the ionic conduction resistance of interfaces between the electrolyte and the active materials of a positive electrode and a negative electrode.

However, battery elements such as the electrolyte, the positive electrode, and the negative electrode of the all-solid-state battery change in volume at a time of a temperature change or charging or discharging. Such a volume change varies the pressure of the inside of the container. There is thus a fear of being unable to sufficiently maintain the performance of the all-solid-state battery.

Accordingly, Japanese Patent Laid-Open No. 2010-34002, for example, discloses a method for adjusting the pressure of the inside of the container by filling an oil into the inside of the container housing the battery elements of the all-solid-state battery, and adjusting the amount of the oil by using a pressurizing pump.

### SUMMARY

Thus providing the pressurizing pump for pumping the oil as pressure control means on an outside of the container in order to suppress variations in the pressure of the inside of the container due to a change in the volume of the all-solid-state battery can be a factor that increases the number of parts of various kinds of electronic apparatuses using the all-solid-state battery and hinder the miniaturization of the various kinds of electronic apparatuses.

In addition, the method for adjusting the pressure of the inside of the container by the pressure control means such as the pressurizing pump causes a time lag from the detection of an instantaneous variation in the pressure of the inside of the container to the adjustment of the amount of the oil. It is thus difficult to suppress an initial pressure change within the container.

Further, even in a case where the charging or discharging of the battery elements is absent, a change in the volume of the oil itself occurs due to a change in environmental temperature, and consequently the pressure of the inside of the container varies. A pressure control device such as the pressurizing pump therefore needs to be operated continuously or intermittently, which causes a loss of electric energy.

It is accordingly an object of the present disclosure to provide a housing container that can adjust the pressure of the inside of the container quickly when the pressure of the inside of the container varies due to a change in the volume of the all-solid-state battery or the oil housed within the container or the like.

A housing container according to the present disclosure includes a plurality of exterior walls, the plurality of exterior walls forming an internal space for housing a content. A part or a whole of the plurality of exterior walls has a pressure adjusting portion formed therein, and the pressure adjusting portion includes a pressure plate that is elastically deformable according to a volume change in the internal space.

It is thereby possible to secure a large variable capacity of the inside of the housing container.

According to the present disclosure, the container is deformed according to a change in the volume of the inside of the container, and thereby the pressure of the inside of the container can be maintained to be similar to that before the change in the volume.

### BRIEF DESCRIPTION OF THE DRAWINGS

FIG. 1 is a diagram illustrating an external appearance of a housing container in a first embodiment of the present disclosure;

FIG. 2 is an A-A sectional view of the housing container;

FIG. 3 is an enlarged view of a pressure adjusting portion in the A-A sectional view of the housing container;

FIG. 4 is a cross-sectional view illustrating a deformed state of the pressure adjusting portion;

FIG. 5 is a sectional view illustrating a pressure adjusting portion not including a retaining portion;

FIG. 6 is a diagram schematically illustrating a state in which a pressurizing pump is connected to the housing container;

FIG. 7 is a diagram illustrating a modification of the housing container;

FIG. 8 is a diagram illustrating an external appearance of a housing container in a second embodiment;

FIG. 9 is an enlarged view of a pressure adjusting portion in a B-B sectional view of the housing container;

FIG. 10 is a diagram illustrating an external appearance of a housing container in a third embodiment;

FIG. 11 is a C-C sectional view of the housing container;

FIG. 12 is a diagram illustrating an external appearance of a housing container in a fourth embodiment;

FIG. 13 is a D-D sectional view of the housing container;

FIG. 14 is a diagram illustrating an external appearance of a housing container in a fifth embodiment;

FIG. 15 is an E-E sectional view of the housing container; and

FIG. 16 is a diagram illustrating changes in the pressure of an internal space with respect to changes in a temperature of a housing container.

### DETAILED DESCRIPTION

Embodiments will hereinafter be described with reference to FIGS. 1 to 16. Incidentally, configurations depicted in the drawings that are referred to in describing the present embodiments are illustrated by extracting principal parts and peripheral configurations necessary in implementing the present embodiments. In addition, the drawings are schematic, and relations, ratios, and the like between the thicknesses and planar dimensions of structures depicted in the drawings are a mere example. Hence, various changes can be made according to design or the like within a range not deviating from a technical concept of the present disclosure.

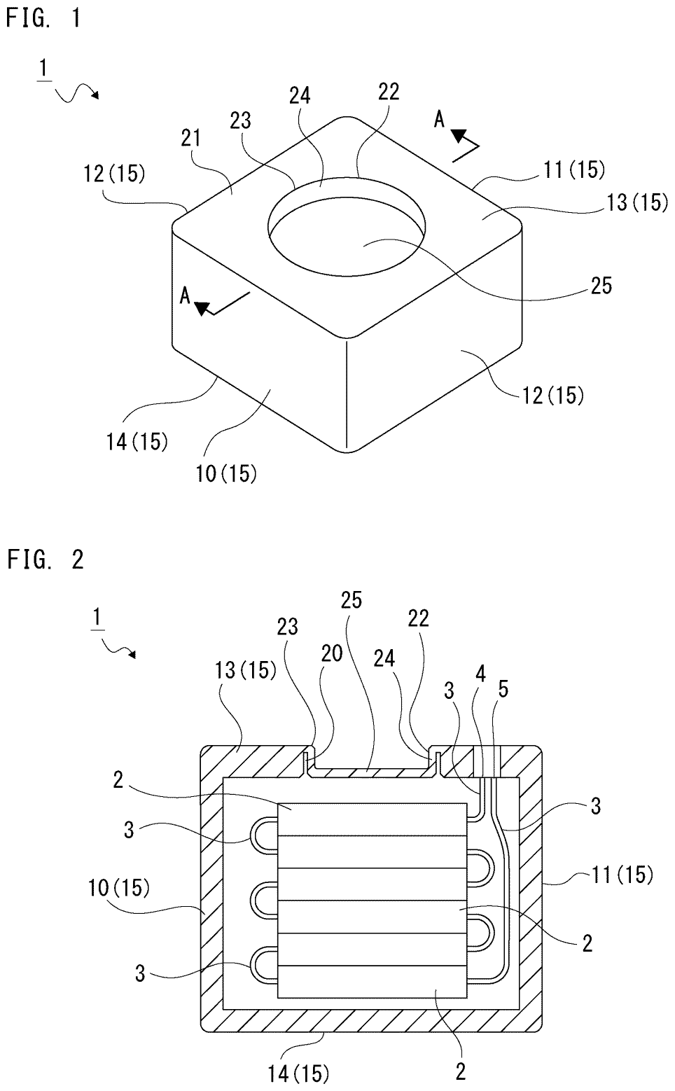

A housing container 1 in a first embodiment will be described with reference to FIGS. 1 to 7. As illustrated in FIG. 1 and FIG. 2, the housing container 1 is formed in substantially a rectangular parallelepipedic shape. The housing container 1 has a front face wall 10 facing a front-rear direction, a rear face wall 11 positioned rearward of the front face wall 10 and facing the front-rear direction, side face walls 12 positioned in such a manner as to be separated from each other in a left-right direction, a top face wall 13 facing an upward-downward direction, and a bottom face wall 14 positioned downward of the top face wall 13 and facing the upward-downward direction. The front face wall 10, the rear face wall 11, the side face walls 12, the top face wall 13, and the bottom face wall 14 are each formed as an exterior wall 15 of the housing container 1. It is to be noted that the front-rear, upward-downward, and left-right directions are for the convenience of description, and are not limited to these directions in carrying out the present disclosure.

In a state in which the housing container 1 is formed, a content that changes in volume due to a factor such as the exertion of a function of the content is disposed in an internal space formed by the plurality of exterior walls 15. The content is, for example, all-solid-state batteries 2 illustrated in FIG. 2. In the all-solid-state batteries 2, respective materials of an electrolyte, a positive electrode, and a negative electrode expand and change in volume at times of temperature changes and charging and discharging.

The all-solid-state batteries 2 are, for example, lithium ion batteries, and are secondary batteries having battery elements including a solid electrolyte. The all-solid-state batteries 2 are coupled in series relation to each other by lead frames 3. The lead frames 3 of both terminals of the all-solid-state batteries 2 coupled to each other are respectively connected to output terminals 4 and 5 for output to the outside of the housing container 1. Incidentally, FIG. 1 does not illustrate a configuration related to the output terminals 4 and 5.

The inside of the housing container 1 is filled with a liquid as a pressurizing medium via a flow passage not illustrated or the like. The all-solid-state batteries 2 arranged inside the housing container 1 are pressurized by the liquid from all directions. When the flow passage is closed and thereby the internal space is sealed in a state in which the all-solid-state batteries 2 are pressurized, for example, the pressurization of the all-solid-state batteries 2 by the liquid is maintained. By thus pressurizing the all-solid-state batteries 2, it is possible to reduce the ionic conduction resistance of an interface between the solid electrolyte and each active material, and therefore maintain the performance of the all-solid-state batteries 2.

An oil such as, a hydraulic fluid is used as the liquid filled into the housing container 1, for example. Incidentally, a gas may be mixed with the filled liquid.

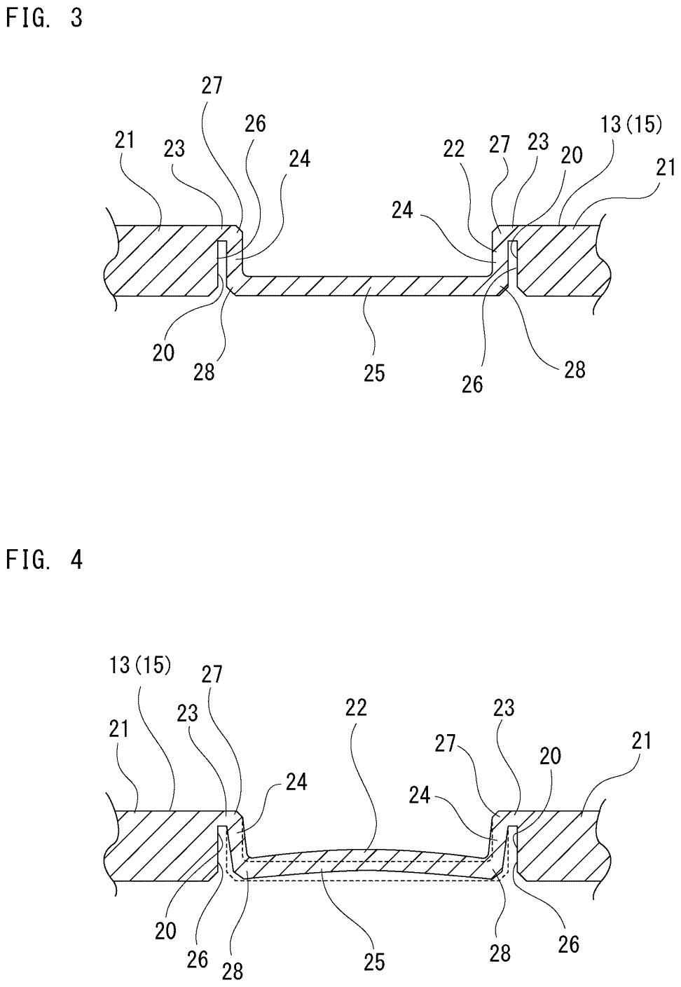

In addition, as illustrated in FIG. 2 and FIG. 3, a wall portion 21 in which an arrangement hole 20 opening in a circular shape is formed and a pressure adjusting portion 22 provided in the arrangement hole 20 and opening in a circular shape in an upward direction (direction toward the external side of the housing container 1) are formed integrally with each other in the top face wall 13 of the housing container 1. The pressure adjusting portion 22 is formed as a recessed portion. The pressure adjusting portion 22 includes an edge portion 23, a retaining portion 24, and a pressure plate 25.

The edge portion 23 is formed in an annular shape so as to project in a radial direction from an edge 26 of the wall portion 21 forming the arrangement hole 20.

The retaining portion 24 is formed so as to be continuous with an end portion 27 of the edge portion 23, and is formed in a cylindrical shape so as to project in a downward direction (direction toward the bottom face wall 14 side). Thus, the retaining portion 24 is formed in such a manner as to be separated from the wall portion 21. In addition, the retaining portion 24 is formed so as to be reversibly elastically deformable according to a deformation of the pressure plate 25.

The pressure plate 25 is formed in a circular shape and a substantially planar shape, and is formed so as to be continuous with a connecting portion 28 of a lower end portion of the retaining portion 24. Thus, the edge portion 23, the retaining portion 24, and the pressure plate 25 are continuously formed integrally with each other. In addition, the pressure plate 25 is formed so as to have a smaller thickness than the thickness of the wall portion 21. Incidentally, the substantially planar shape referred to here includes not only a flat surface but also a curved surface approximate to a flat surface.

The pressure plate 25 is formed in a circular shape because the circular shape has infinite line symmetry axes and does not cause stress to concentrate thereon easily, and therefore a large variable capacity of the inside of the housing container 1 according to the deformation of the pressure plate 25 can be secured. In addition, the circular shape is a shape that facilitates processing, and thus the processing of the pressure plate 25 is facilitated.

The pressure plate 25 is formed as an elastic body that is reversibly elastically deformable according to a pressure difference between the inside and the outside of the housing container 1. When the volume of the inside of the housing container 1 changes and thereby a pressure difference occurs, the pressure plate 25 is deformed, and thereby the capacity of the housing container 1 changes, so that the pressure of the inside of the housing container 1 is maintained to be similar to that before the change in the volume.

The material of the pressure plate 25 preferably satisfies conditions such as a wide elastic deformation range that changes little in an environmental temperature range in which the housing container 1 is placed and in a usage temperature range of the all-solid-state batteries 2, a high stiffness that changes little in the environmental temperature range in which the housing container 1 is placed and in the usage temperature range of the all-solid-state batteries 2, a large breaking elongation that changes little in the environmental temperature range in which the housing container 1 is placed and in the usage temperature range of the all-solid-state batteries 2, a high creep resistance in the environmental temperature range in which the housing container 1 is placed and in the usage temperature range of the all-solid-state batteries 2, a high heat resistance in the environmental temperature range in which the housing container 1 is placed and within the usage temperature range of the all-solid-state batteries 2, no cold shortness occurring in the environmental temperature range in which the housing container 1 is placed and within the usage temperature range of the all-solid-state batteries 2, and an excellent chemical resistance.

Specifically, a steel material hardened to HRc 40 or more, having a 0.2% proof stress of 100 kgf/mm² or more, and having a breaking elongation of 10% or more is preferable. In addition, a steel material hardened to HRc 50 or more, having a 0.2% proof stress of 120 kgf/mm² or more, and having a breaking elongation of 10% or more is more preferable. Applied steel materials include, for example, SUS440, SUS420J2, a material equivalent thereto, or the like as a martensitic stainless steel, SUS631, SUS632J1, a material equivalent thereto, or the like as a precipitation hardened stainless steel, SKD11, SKD61, SKH51, a material equivalent thereto, or the like as a tool steel, and SUP6, SUP9, SUP9A, SUP10, SUP11A, SUP13, a material equivalent thereto, or the like as a spring steel material. This is because a high springiness is obtained in a case of a steel material whose hardness is increased by heat treatment, work hardening, or the like. In addition, a rubber-based material has a very wide elasticity range, and has very high superiority when increased in thickness, so that the rubber-based material can be applied as a material for the pressure plate 25.

In addition, examples of the material for the pressure plate 25 include varieties defined in “4. Materials” of JIS B 8267:20222 (SS300, SS400, SB410, SB480, SB450M, SB480M, SM400A, SM400B, SM400C, SM490A, SM490B, SM490C, SMA400 (all), SMA490 (all), SPV235, SPV315, SPV410, SPV450, SPV490, SBV1A, SBV1B, SBV2, SBV3, SLA235A, SLA235B, SLA325A, SLA325B, SLA365, SLA410, SL2N255, SL3N255, SL3N275, SF340A, SF390A, SF440A, SFVC2A, SFVAF1, SHVAF2, SFVAF12, SFVAF11A, SFVAF11B, SFVAF22A, SFVAF22B, SFVAF21A, SFVAF21B, SFVAF5A, SFVAF5B, SFVAF5C, SFVAF5D, SFVAF9, SFVCMF22B, SFVCMF22V, SFVCMF3V, SUS304, SUS304L, SUS309S, SUS310S, SUS316, SUS316L, SUS316Ti, SUS317, SUS317L, SUS321, SUS347, SUS405, SUS410S, SUS430, SUSF304, SUSF304H, SUSF304L, SUSF310, SUSF316, SUSF316H, SUSF316L, SUSF317, SUSF317L, SUSF321, SUSF321H, SUS347H, SUSF410, SCMV1, SCMV2, SCMV3, SCMV4, SCMV5, SCMV6, Hastelloy B, Hastelloy C276, nickel, copper, a copper alloy (brass), and aluminum (3004)) as metals, SUS420J2 and SUS440 as stainless steels, SKD11, SKD61, and SKD12 as quenched and tempered steels, SKH51 as a high-speed steel, SUP6, SUP9, SUP9A, SUP10, SUP11A, and SUP13 as spring steels, and a 5000 or 7000 series as an aluminum alloy. Also included are fiber reinforced PA, POM, PC, PET, PEEK, PPS, and LCP as plastics as well as a nitrile rubber, an ethylene propylene rubber, a silicon rubber, a hydrogenated nitrile rubber, a fluorine rubber, and a urethane rubber as rubber-based materials. It is to be noted that the above are an example of materials for the pressure plate 25, and there is no limitation to this. In addition, the whole of the housing container 1 may be formed by a material described above, or a part thereof including the pressure plate 25 may be formed by a material described above.

Next, a deformation of the pressure adjusting portion 22 according to a change in the volume of the inside of the housing container 1 will be described with reference to FIGS. 3 to 5. Suppose that the internal space of the housing container 1 is sealed in a state of being filled with a liquid as a pressurizing medium, and that the all-solid-state batteries 2 arranged in the internal space continue to be pressurized by the filled liquid.

The respective materials of electrolytes, positive electrodes, and negative electrodes of the all-solid-state batteries 2 may expand and increase in volume due to a temperature change or charging or discharging. In addition, the pressurizing medium such as the filled liquid may expand and increase in volume due to a temperature change. From these factors, the volume of the whole of the internal space of the housing container 1 may increase.

As illustrated in FIG. 4, when the volume of the inside of the housing container 1 increases, the pressure plate 25 is bent and deformed in the shape of a curved surface projecting in the upward direction (to the external side of the housing container 1). Incidentally, a broken line part in FIG. 4 represents the pressure adjusting portion 22 before the deformation.

The capacity of the housing container 1 can be increased by the bending and deformation of the pressure plate 25 according to the increase in the volume of the inside of the housing container 1. Accordingly, variation in the pressure of the inside of the housing container 1 is suppressed, so that the pressurization of the all-solid-state batteries 2 can be maintained in a similar manner to that before the change in the volume. Consequently, the performance of the all-solid-state batteries 2 can be maintained without being compromised.

In addition, when the pressure plate 25 is bent and deformed, a bending stress from the pressure plate 25 is applied to the lower end portion (connecting portion 28) of the retaining portion 24 as a supporting point of the deformation, and the connecting portion 28 is pulled to the central side of the pressure plate 25. Accordingly, the retaining portion 24 is inclined, so that the bending stress caused by the bending and deformation of the pressure plate 25 is absorbed.

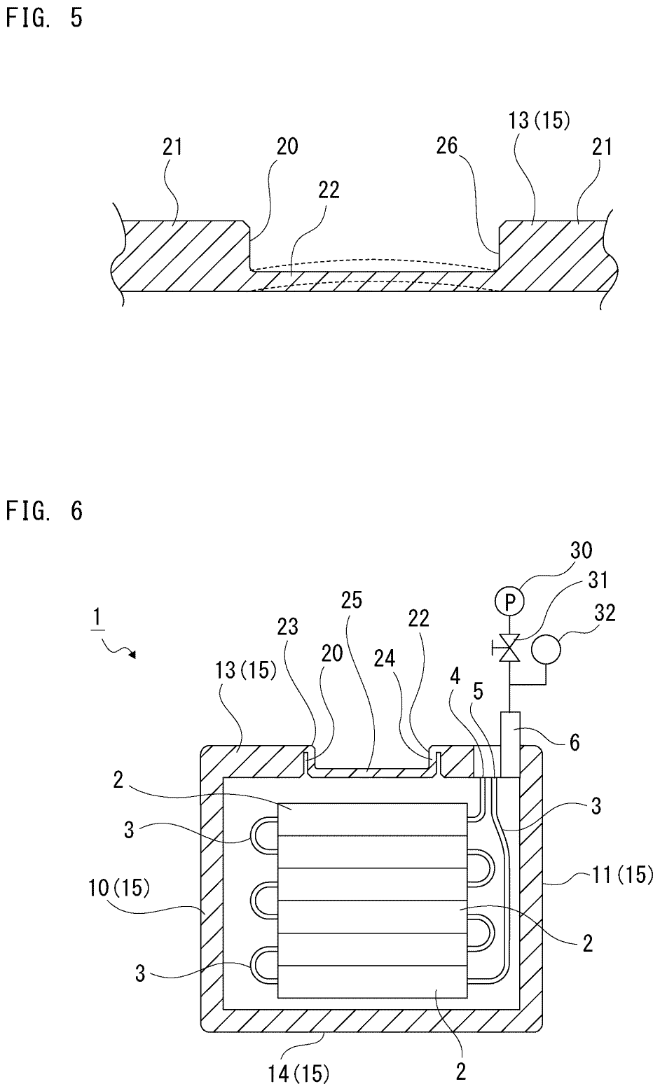

FIG. 5 illustrates, for example, a case where the pressure adjusting portion 22 is not provided with the retaining portion 24 but the pressure plate 25 is formed integrally with the edge 26 of the wall portion 21. Even in this case, the pressurization of the all-solid-state batteries 2 can be maintained in a similar manner to that before the change in the volume by the bending and deformation of the pressure plate 25 according to variation in the pressure of the inside of the housing container 1.

However, a larger variable capacity of the inside of the housing container 1 according to the deformation of the pressure plate 25 can be secured in the example illustrated in FIG. 3 and FIG. 4 in which example the retaining portion 24 is provided than in the example illustrated in FIG. 5. Therefore, when the retaining portion 24 is provided to the pressure adjusting portion 22, the pressure plate 25 can be deformed with a margin for a large change in the volume of the inside of the housing container 1.

Incidentally, in the above description, an example has been described in which the volume of the inside of the housing container 1 is increased by the expansion of the all-solid-state batteries 2 or the expansion of the liquid due to a temperature change. However, there is a case where the volume of the inside of the housing container 1 is decreased by, for example, a contraction of the liquid due to a temperature change or the like.

In this case, the pressure of the inside of the housing container 1 can be maintained to be similar to that before the change in the volume by the bending and deformation of the pressure plate 25 in the shape of a curved surface projecting to the internal side of the housing container 1. At this time, the connecting portion 28 moves so as to separate from the central side of the pressure plate 25 due to a bending stress from the pressure plate 25. Accordingly, the retaining portion 24 is inclined, so that the bending stress caused by the bending and deformation of the pressure plate 25 is absorbed.

In addition, as illustrated in FIG. 6, pressure control means for controlling the pressure of the inside of the housing container 1 may be provided in addition to the housing container 1. The pressure control means is, for example, a pressurizing pump 30 that pumps the oil in the case where the inside of the housing container 1 is filled with the oil as the pressurizing medium.

The pressurizing pump 30 is connected to a pipe line 6 that couples the housing container 1 and an oil storage tank not illustrated to each other. The pressurizing pump 30 can adjust the pressure of the internal space of the housing container 1 by adjusting the pressurization of the oil made to flow into the housing container 1.

The pipe line 6 is provided with an opening and closing valve 31 that opens and closes a flow passage of the oil between the pressurizing pump 30 and the housing container 1. When the flow passage is closed by the opening and closing valve 31 and thereby the internal space of the housing container 1 is sealed in a state in which the oil is pressurized by the pressurizing pump 30, a pressurized state of the inside of the housing container 1 can be maintained irrespective of operation of the pressurizing pump 30.

In addition, a pressure gage 32 that measures the pressure of the inside of the housing container 1 is connected to the pipe line 6. The operation of the pressurizing pump 30 and the opening and closing valve 31 is controlled according to the pressure of the inside of the housing container 1 which pressure is measured by the pressure gage 32. The pressurization of the oil is thereby adjusted such that the pressure of the inside of the housing container 1 is constant.

However, the pressure adjustment using the pressurizing pump 30 causes a time lag from the detection of a variation in the pressure of the inside of the housing container 1 by the pressure gage 32 to the adjustment of the pressurization of the oil. It is thus difficult to suppress an initial change in the pressure of the inside.

Accordingly, by using the housing container 1, it becomes possible to make the pressure adjustment quickly by a deformation of the pressure adjusting portion 22 even for an initial pressure change that is difficult to adjust by the pressurizing pump 30. The housing container 1 can adjust the pressure of the inside without the provision of the external pressure control means such as the pressurizing pump 30. However, when the housing container 1 is thus used in conjunction with the pressure control means, the housing container 1 can play a role of covering a period in which it is difficult to make the pressure adjustment by the pressure control means.

Incidentally, in the above description, as illustrated in FIG. 1, an example has been described in which the pressure adjusting portion 22 is formed in the top face wall 13. However, the pressure adjusting portion 22 may be formed in one or more of the plurality of exterior walls 15.

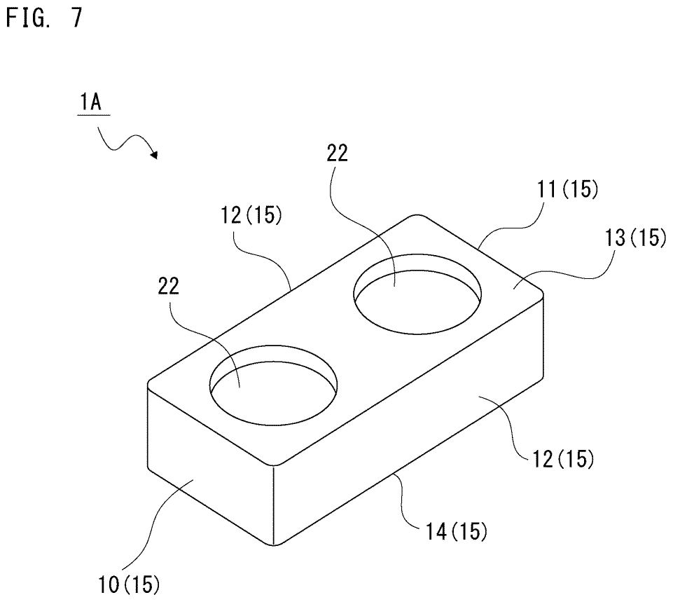

In addition, the pressure adjusting portion 22 formed in one of the plurality of exterior walls 15 is not limited to one pressure adjusting portion 22, and a plurality of pressure adjusting portions 22 may be formed therein. For example, as in a housing container 1A illustrated in FIG. 7, two pressure adjusting portions 22 may be formed in the top face wall 13.

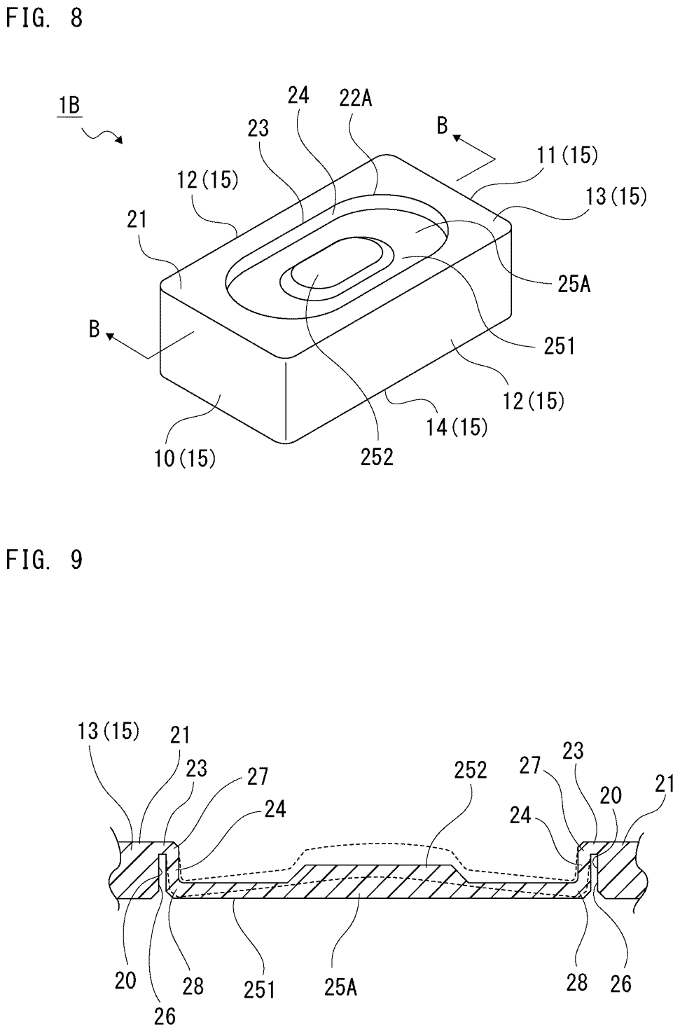

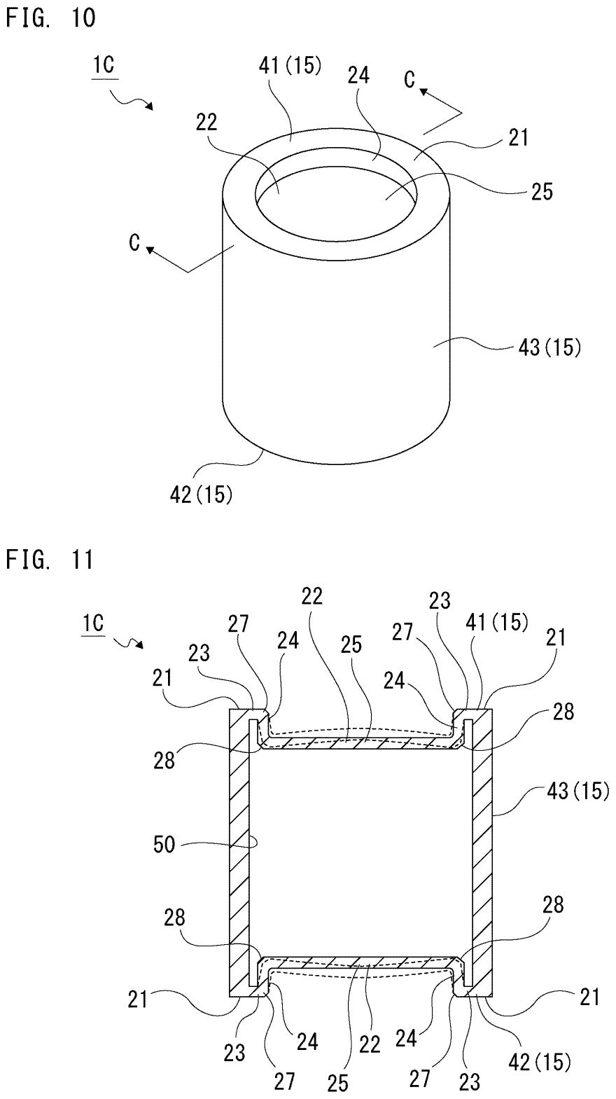

A housing container 1B in a second embodiment will be described with reference to FIG. 8 and FIG. 9. Incidentally, description of configurations similar to those of the housing container 1 in the first embodiment will be omitted.

As illustrated in FIG. 8, the housing container 1B is formed in a substantially rectangular parallelepipedic shape such that a length in the front-rear direction of the top face wall 13 is longer than a length in the left-right direction of the top face wall 13.

In addition, as illustrated in FIG. 8 and FIG. 9, a wall portion 21 in which an arrangement hole 20 opening in an elliptic shape is formed and a pressure adjusting portion 22A provided in the arrangement hole 20 and opening in an elliptic shape in the upward direction (direction toward the external side of the housing container 1B) are formed integrally with each other in the top face wall 13.

The pressure adjusting portion 22A includes an edge portion 23, a retaining portion 24, and a pressure plate 25A. As with the pressure plate 25 in the first embodiment, the pressure plate 25A is an elastic body that is reversibly elastically deformable. The pressure plate 25A is formed in an elliptic shape.

Because the pressure plate 25A has an elliptic shape that facilitates processing, the area of the pressure plate 25A can be secured easily even in the housing container 1B having a high aspect ratio or a high slenderness ratio. Consequently, a larger variable capacity of the inside of the housing container 1B according to the deformation of the pressure plate 25A can be secured.

In addition, because of the elliptic shape, when the pressure plate 25A is bent and deformed as indicated by a broken line in FIG. 9, stress does not easily concentrate, and the pressure plate 25A can be deformed with a margin for a change in the volume of the inside of the housing container 1B. This also enables a large variable capacity of the inside of the housing container 1B to be secured.

In addition, a thin portion 251 and a thick portion 252 that is formed more to the central side of the pressure plate 25A than the thin portion 251 and has a larger thickness than the thin portion 251 are formed integrally with each other in the pressure plate 25A. The provision of the thick portion 252 can improve the strength of a central portion of the pressure plate 25A, and prevent stress from concentrating.

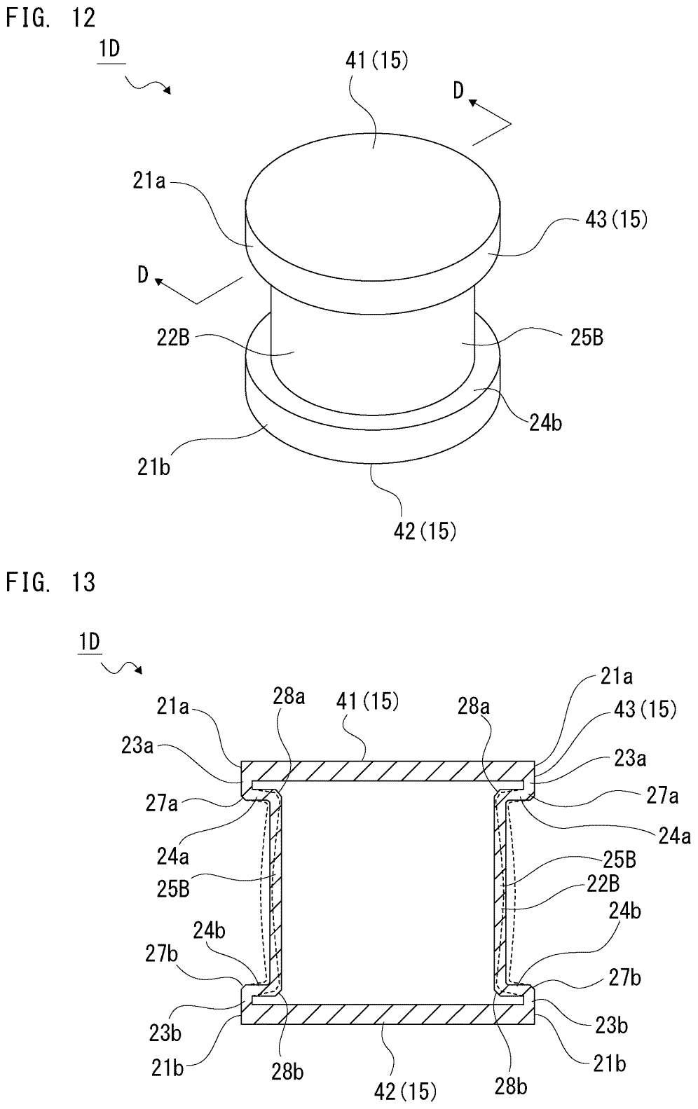

A housing container 1C in a third embodiment will be described with reference to FIG. 10 and FIG. 11. Incidentally, description of configurations similar to those of the foregoing embodiments will be omitted.

As illustrated in FIG. 10, the housing container 1C is formed in a substantially cylindrical shape. The housing container 1C has a top face wall 41 facing the upward-downward direction, a bottom face wall 42 positioned downward of the top face wall 41 and facing the upward-downward direction, and a side face wall 43. The upward-downward direction in this case can be reworded as a direction perpendicular to the circumferential direction of the side face wall 43. The top face wall 41, the bottom face wall 42, and the side face wall 43 are each formed as an exterior wall 15 of the housing container 1C. The same applies to housing containers 1D and 1E to be described later. It is to be noted that the upward and downward directions are for the convenience of description, and are not limited to these directions in carrying out the present disclosure.

In a state in which the housing container 1C is formed, though not illustrated, all-solid-state batteries 2 as illustrated in FIG. 1 are arranged in an internal space formed by the plurality of exterior walls 15 as illustrated in FIG. 11. The same applies to the housing containers 1D and 1E to be described later.

A wall portion 21 in which an arrangement hole 20 opening in a circular shape is formed and a pressure adjusting portion 22 provided in the arrangement hole 20 and opening in a circular shape in the upward direction (direction toward the external side of the housing container 1C) are formed integrally with each other in each of the top face wall 41 and the bottom face wall 42 of the housing container 1C.

When the volume of the inside of the housing container 1C is increased by, for example, an expansion of the all-solid-state batteries 2 or the like, the pressure plate 25 of the pressure adjusting portion 22 is bent and deformed in the shape of a curved surface projecting to the external side of the housing container 1C, as indicated by a broken line in FIG. 11. Because the pressure plate 25 is thus deformed with a change in the volume of the inside of the housing container 1C, the pressure of the inside of the housing container 1C is maintained to be similar to that before the change in the volume, and a state of pressurizing the all-solid-state batteries 2 can be maintained.

In addition, because the pressure adjusting portion 22 is formed in both of the top face wall 41 and the bottom face wall 42, a larger variable capacity of the inside of the housing container 1 according to the deformation of the plurality of pressure plates 25 can be secured.

Incidentally, in the above description, an example has been described in which the pressure adjusting portion 22 is formed in both of the top face wall 41 and the bottom face wall 42. However, the pressure adjusting portion 22 may be formed in one of the top face wall 41 and the bottom face wall 42.

A housing container 1D in a fourth embodiment will be described with reference to FIG. 12 and FIG. 13. Incidentally, description of configurations similar to those of the foregoing embodiments will be omitted.

As illustrated in FIG. 12, the housing container 1D is formed in a substantially cylindrical shape. The housing container 1D has a top face wall 41, a bottom face wall 42, and a side face wall 43, which are each formed as an exterior wall 15 of the housing container 1D.

In the side face wall 43 of the housing container 1D, a first wall portion 21a formed so as to be continuous with the top face wall 41, a second wall portion 21b formed so as to be continuous with the bottom face wall 42, and a pressure adjusting portion 22B located between the first wall portion 21a and the second wall portion 21b are continuously formed integrally with each other.

As illustrated in FIG. 13, the pressure adjusting portion 22B includes a first edge portion 23a, a second edge portion 23b, a first retaining portion 24a, a second retaining portion 24b, and a pressure plate 25B.

The first edge portion 23a is formed in a cylindrical shape so as to project downward from a lower end portion of the first wall portion 21a. In addition, the first retaining portion 24a is formed in an annular shape so as to project in the radial direction from a lower end portion 27a of the first edge portion 23a.

On the other hand, the second edge portion 23b is formed in a cylindrical shape so as to project upward from an upper end portion of the second wall portion 21b. In addition, the second retaining portion 24b is formed in an annular shape so as to project in the radial direction from an upper end portion 27b of the second edge portion 23b.

The pressure plate 25B is continuous from an end portion 28a of the first retaining portion 24a and connects an end portion 28b of the second retaining portion 24b to the end portion 28a. The pressure plate 25B is thus formed integrally with the end portion 28a and the end portion 28b. The pressure plate 25B is formed in a cylindrical shape. As with the pressure plate 25 in the first embodiment, the pressure plate 25B is an elastic body that is reversibly elastically deformable. The pressure plate 25B is formed in a cylindrical shape because a tubular part has a symmetric shape where stress does not easily concentrate, and therefore a large variable capacity of the inside of the housing container 1D according to the deformation of the pressure plate 25B can be secured.

When the volume of the internal space of the housing container 1D is increased by, for example, an expansion of the all-solid-state batteries 2 or the like, the pressure plate 25B is bent and deformed in the shape of a curved surface projecting to the external side of the housing container 1D, as indicated by a broken line in FIG. 13. Because the pressure plate 25B is thus deformed with the change in the volume of the inside of the housing container 1D, the pressure of the inside of the housing container 1D is maintained so as to be similar to that before the change in the volume, and a state of pressurizing the all-solid-state batteries 2 is maintained.

When the pressure plate 25B having a cylindrical shape is formed in the side face wall 43 of the housing container 1D, a larger elastically deformable area can be secured than when the pressure plate 25 as illustrated in FIG. 11 is provided to the top face wall 41 or the bottom face wall 42. Consequently, a larger variable capacity of the inside of the housing container 1D according to the deformation of the pressure plate 25B can be secured. This is useful particularly in a case where a larger variable capacity needs to be secured, such as a case where the amount of the pressurizing medium filled into the housing container 1D is large or a case where the inside is pressurized at a high pressure. In addition, the top face wall 41 and the bottom face wall 42 do not need to be increased in size in order to provide large pressure plates 25, so that the housing container 1D can be miniaturized.

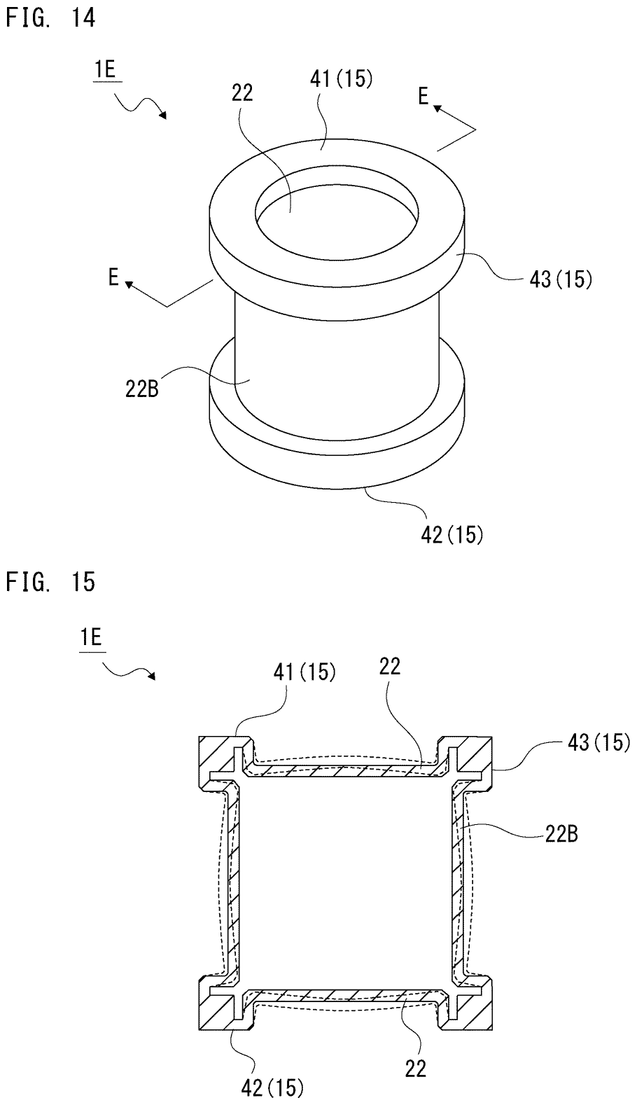

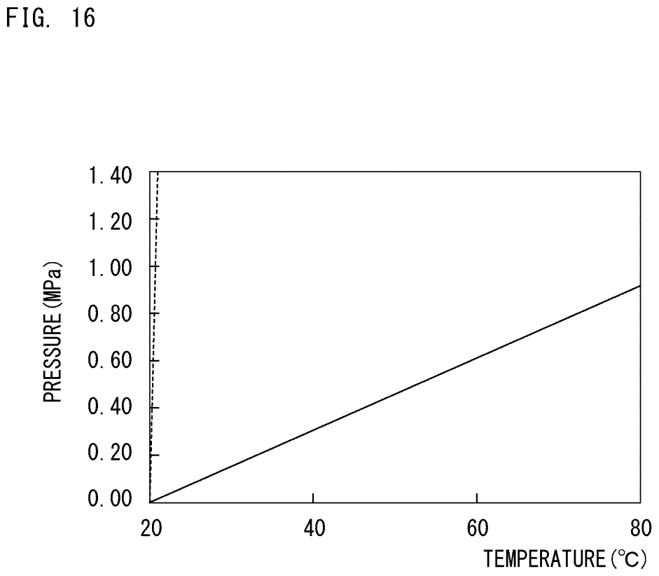

A housing container 1E in a fifth embodiment will be described with reference to FIG. 14 and FIG. 15. Incidentally, description of configurations similar to those of the foregoing embodiments will be omitted.

The housing container 1E is formed in a substantially cylindrical shape. The housing container 1E has a top face wall 41, a bottom face wall 42, and a side face wall 43, which are each formed as an exterior wall 15 of the housing container 1E. In addition, as in the housing container 1C illustrated in FIG. 10, the pressure adjusting portion 22 is formed in each of the top face wall 41 and the bottom face wall 42, and as in the housing container 1D illustrated in FIG. 12, the pressure adjusting portion 22B is formed in the side face wall 43.

A larger elastically deformable area can be secured by thus providing each of the top face wall 41, the bottom face wall 42, and the side face wall 43 with the pressure adjusting portion. Consequently, an even larger variable capacity of the inside of the housing container 1E can be secured.

Incidentally, in the above description, an example has been described in which the pressure adjusting portion 22 is formed in both of the top face wall 41 and the bottom face wall 42. However, the pressure adjusting portion 22 may be formed in one of the top face wall 41 and the bottom face wall 42.

The housing container 1 (1A, 1B, 1C, 1D, 1E) in each of the embodiments described above has the plurality of exterior walls 15. The all-solid-state batteries 2 are housed in the internal space formed by the plurality of exterior walls 15. In addition, according to the housing container 1 (1A, 1B, 1C, 1D, 1E), a part or the whole of the plurality of exterior walls 15 has the pressure adjusting portion 22 (22A, 22B) formed therein. The pressure adjusting portion 22 (22A, 22B) includes the pressure plate 25 (25A, 25B) that is elastically deformable according to a volume change in the internal space (see FIG. 1, FIG. 7, FIG. 8, FIG. 10, FIG. 12, FIG. 14, or the like).

Consequently, a large variable capacity of the inside of the housing container 1 (1A, 1B, 1C, 1D, 1E) can be secured. Hence, the container is deformed according to a change in the volume of the inside of the housing container 1 (1A, 1B, 1C, 1D, 1E), so that the pressure of the inside can be maintained to be similar to that before the change in the volume.

FIG. 16 is a graph illustrating changes in the pressure of the inside of the container according to temperature changes. An axis of abscissas indicates the temperature (C) of the inside of the container. An axis of ordinates indicates the pressure (MPa) of the inside of the container. In addition, a solid line in the graph represents the experimental data of a housing container (for example, the housing container 1) provided with the pressure adjusting portion 22, and a broken line represents the experimental data of a housing container not provided with the pressure adjusting portion 22.

Looking at this graph, it is clear that the housing container provided with the pressure adjusting portion 22 significantly suppresses a rise in the pressure of the inside of the container with a rise in temperature as compared with the housing container not provided with the pressure adjusting portion 22. It is clear also from this that the formation of the pressure adjusting portion 22 in the housing container 1 advantageously acts to suppress a change in the pressure of the inside of the housing container 1 with a change in the volume.

It is to be noted that while description has been made of an example of the all-solid-state batteries 2 as the content to be disposed in the internal space of the housing container 1 (1A, 1B, 1C, 1D, 1E) in each of the embodiments, the content is not limited to this. For any content, the housing container 1 (1A, 1B, 1C, 1D, 1E) according to the present disclosure can hold the pressure of the internal space constant. Effects thereof are exerted more remarkably particularly in a case of a content that changes in volume due to a factor such as the exertion of a function of the content.

Finally, the effects described in the present disclosure are illustrative and not limited. Other effects may be produced, or a part of the effects described in the present disclosure may be produced. In addition, all of the combinations of the configurations described in the embodiments are not necessarily essential to solving the problems.

What is claimed is:

1. A housing container comprising:
a plurality of exterior walls, the plurality of exterior walls forming an internal space for housing a content, wherein
a part or a whole of the plurality of exterior walls has a pressure adjusting portion formed therein, and
the pressure adjusting portion includes a pressure plate that is elastically deformable according to a volume change in the internal space.

2. The housing container according to claim 1, wherein
the pressure adjusting portion includes
an edge portion opening to an outside of the container, and
a retaining portion that is formed so as to be continuous from the pressure plate to the edge portion and is elastically deformable according to a deformation of the pressure plate.

3. The housing container according to claim 1, wherein
the pressure plate is formed in a circular shape.

4. The housing container according to claim 1, wherein
the pressure plate is formed in an elliptic shape.

5. The housing container according to claim 4, wherein
the pressure plate includes
a thin portion, and
a thick portion that is formed more to a central side of the pressure plate than the thin portion and has a larger thickness than the thin portion.

6. The housing container according to claim 1, wherein
the housing container is formed so as to be cylindrical by the plurality of exterior walls.

7. The housing container according to claim 6, wherein
the pressure adjusting portion is formed in a side face wall among the plurality of exterior walls.

8. The housing container according to claim 6, wherein
the pressure adjusting portion is formed in at least one of a top face wall or a bottom face wall among the plurality of exterior walls.
